(19) United States
(12) Patent Application Publication
(10) Pub. No.: US 2009/0177819 A1
(43) Pub. Date: Jul. 9, 2009

(54) INTEGRATED CIRCUIT CARDS INCLUDING MULTIPLE COMMUNICATION INTERFACES AND RELATED METHODS OF OPERATION

(75) Inventor: Byung Yoon Kang, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd

(21) Appl. No.: 12/349,003

(22) Filed: Jan. 6, 2009

(30) Foreign Application Priority Data
Jan. 8, 2008 (KR) 10-2008-0002057

(51) Int. Cl. G06F 13/00

(52) U.S. Cl. 710/105

(57) ABSTRACT

A multi-interface integrated circuit (IC) card includes a first communication interface configured to communicate with a host device in a first protocol mode, a second communication interface configured to communicate with the host device in a second protocol mode different than the first protocol mode, and a controller configured to detect a voltage supplied by the host device and a counter value associated therewith. The controller is configured to enable either the first interface or the second interface according to the detected voltage and the counter value. Related methods of operation are also discussed.

### CROSS REFERENCE TO RELATED APPLICATION

This application claims priority under 35 U.S.C. § 119 to Korean Patent Application No. 10-2008-0002057, filed on Jan. 8, 2008, in the Korean Intellectual Property Office, the disclosure of which is incorporated by reference herein in its entirety.

### FIELD OF THE INVENTION

The present invention relates to integrated circuit (IC) cards and methods of operating the same.

### BACKGROUND

An Integrated Circuit (IC) card is card that includes a logic circuit, which may be embedded therein, as well as one or more physical interfaces. Such an IC card may be configured to perform various functions by communicating with various external host devices, for example, a portable or mobile terminal, a personal computer (PC), an IC card adapter-writer/reader, a digital camera, a digital portable multimedia player, etc.

Many IC cards may communicate with host devices in accordance with a predetermined standard, for example, using an International Standard Organization (ISO) protocol mode (for example, ISO 7816 standard), a Multi Media Card (MMC) protocol mode, an InterChip (IC_USB) protocol mode, and/or a Universal Serial Bus (USB) protocol mode.

However, such conventional IC cards may support only one protocol mode. When a host device does not communicate using the protocol mode supported by the IC card, the IC card and the host device may not be able to communicate with each other. For example, when an IC card that supports a MMC protocol mode is connected to a PC, the PC may be required to communicate using the same protocol mode (e.g., the MMC protocol mode) as the IC card. Accordingly, if the PC is configured to communicate using only a USB protocol mode, the IC card and the PC in the above example may not communicate with each other. Thus, a user may be required to carry several IC cards, each configured to communicate according to a different protocol mode, or a host device may require additional hardware to support various protocol modes, which may result in increased cost and/or lower efficiency.

### SUMMARY

According to some embodiments of the present invention, a multi-interface integrated circuit (IC) card includes a first interface configured to communicate with a host device in a first protocol mode, a second interface configured to communicate with the host device in a second protocol mode different than the first protocol mode, and a controller configured to detect a level of a driving voltage input from the host device, compare the detected driving voltage with a reference voltage, and enable either the first interface or the second interface according to the comparison.

According to other embodiments of the present invention, a multi-interface integrated circuit (IC) card includes a first interface configured to communicate with a host device in a first protocol mode, a second interface configured to communicate with the host in a second protocol mode different than the first protocol mode, and a controller configured to detect a counter value at a time point when a driving voltage input from the host device reaches a first voltage level, compare the detected counter value with a reference counter value, and enable either the first interface or the second interface according to the comparison.

According to further embodiments of the present invention, a multi-interface integrated circuit (IC) card includes a first communication interface configured to communicate with a host device in a first protocol mode, a second communication interface configured to communicate with the host device in a second protocol mode different than the first protocol mode, and a controller configured to detect a voltage supplied by the host device and a counter value associated therewith. The controller is configured to enable either the first interface or the second interface according to the detected voltage and the counter value.

In some embodiments, the controller may be configured to detect the voltage in response to the counter value, compare the detected voltage with a reference voltage, and enable either the first interface or the second interface in response to the comparison. For example, the controller may include a counter configured to output the counter value therefrom at a predetermined time, a voltage detection unit coupled to the host device and configured to receive the voltage supplied thereby, and a processing unit coupled to the counter and the voltage detection unit. The processing unit may be configured to detect the voltage in response to the counter value from the counter, compare the detected voltage with the reference voltage, and output an enable signal to enable either the first interface or the second interface in response to the comparison.

In other embodiments, the processing unit may be configured to enable the first interface in response to the comparison indicating that the detected voltage is less than the reference voltage, and may be configured to enable the second interface in response to the comparison indicating that the voltage is greater than the reference voltage.

In some embodiments, the counter may be configured to output a second counter value after the predetermined time. The processing unit may be configured to detect a second voltage from the host device in response to the second counter value from the counter, compare the detected second voltage with the reference voltage, and output the enable signal in response to the second comparison.

In other embodiments, the first and second counter values may be consecutive counter values, and the counter may be configured to output the second counter value by incrementing the first counter value in response the first comparison indicating that the first voltage is less than the reference voltage.

In some embodiments, the processing unit may be configured to enable the second interface in response to the second comparison indicating that the second voltage is greater than the reference voltage. The processing unit may be configured to enable the first interface in response to the first and second comparisons indicating that the respective first and second voltages are substantially equal and less than the reference voltage.

In other embodiments, the controller may include a Power-On Reset (POR) coupled to the counter and configured to generate an initialization signal in response to the voltage from the host device. The counter may be configured to initiate a counting operation whereby an initial value is repeatedly incremented to provide the counter value at the predetermined time in response to the initialization signal.

In some embodiments, the controller may include a counter configured to receive a signal from a Power-On Reset (POR) and output the counter value therefrom at a predetermined time in response to the signal. The controller may further include a voltage detection unit coupled to the host device and the counter and configured to detect the voltage supplied thereby in response to the counter value from the counter, and a processing unit coupled to the voltage detection device and configured to compare the detected voltage with the reference voltage and output an enable signal to enable either the first interface or the second interface in response to the comparison.

In other embodiments, the controller may be configured to detect the counter value in response to a voltage comparison of the detected voltage from the host device and a reference voltage, compare the detected counter value with a reference counter value, and enable either the first interface or the second interface in response to the counter value comparison. For example, the controller may include a voltage detection unit configured to detect the voltage from the host device and compare the detected voltage with the reference voltage, a counter coupled to the voltage detection unit and configured to output the counter value therefrom in response to a voltage comparison result indicating that the detected voltage is greater than the reference voltage, and a processing unit coupled to the counter. The processing unit may be configured to compare the detected counter value with the reference counter value and output an enable signal to enable either the first interface or the second interface in response to a counter value comparison result.

In some embodiments, the processing unit may be configured to enable the first interface in response to the counter value comparison result indicating that the detected counter value is less than the reference counter value, and enable the second interface in response to the counter value comparison result indicating that the detected counter value is greater than the reference counter value.

In other embodiments, the controller may include a Power-On Reset (POR) coupled to the counter and configured to generate an initialization signal in response to the voltage supplied by the host device. The counter may be configured to initiate a counting operation whereby an initial value is repeatedly incremented in response to the initialization signal from the POR, and terminate the counting operation to provide the counter value in response to the voltage comparison result indicating that the voltage is greater than or equal to the reference voltage.

In some embodiments, the first interface may be an InterChip (IC_USB) interface, and the second interface may be a Universal Serial Bus (USB) interface.

According to still further embodiments of the present invention, in a method for controlling access to data stored on multi-interface integrated circuit (IC) card including first and second communication interfaces configured to communicate with a host device using different protocols, a controller detects a voltage supplied by the host device and a counter value associated therewith. The controller enables either the first interface or the second interface according to the detected voltage and the counter value.

In some embodiments, the counter value may be provided from a counter included in the IC card, and the voltage may be detected in response to the counter value from counter. The detected voltage may be compared with a reference voltage, and an enable signal may be output to enable either the first interface or the second interface in response to the comparison.

In other embodiments, a second counter value may be provided from the counter after the predetermined time, and a second voltage from the host device may be detected in response to the second counter value from the counter. The detected second voltage may be compared with the reference voltage, and the enable signal may be output in response to the comparison of the second voltage.

In some embodiments, the enable signal may be output to enable the second interface in response to the comparison of the second voltage indicating that the second voltage is greater than the reference voltage, and the enable signal may be output to enable the first interface in response to the comparisons of the first and second voltages indicating that the respective first and second voltages are substantially equal and less than the reference voltage.

In other embodiments, the voltage supplied by the host device may be detected and compared with a reference voltage, and the counter value may be provided from a counter in response to a voltage comparison result indicating that the detected voltage is greater than the reference voltage. The detected counter value may be compared with the reference counter value, and an enable signal may be output to enable either the first interface or the second interface in response to a counter value comparison result.

In some embodiments, counting operation may be initiated whereby an initial value is repeatedly incremented in response to an initialization signal from a Power-On Reset (POR), and the counting operation may be terminated to provide the counter value in response to the voltage comparison result indicating that the voltage is greater than or equal to the reference voltage.

### BRIEF DESCRIPTION OF THE DRAWINGS

FIG. 1 is a block diagram of a multi-interface IC card according to some embodiments of the present invention;

FIG. 2 is a block diagram of a multi-interface IC card according to other embodiments of the present invention;

FIG. 3 is a flowchart illustrating methods of operating the multi-interface IC cards of FIG. 1 and/or FIG. 2;

FIG. 4 is a graph illustrating a driving voltage supplied to the multi-interface IC cards of FIG. 1 and/or FIG. 2;

FIG. 5 is a block diagram of a multi-interface IC card according to further embodiments of the present invention;

FIG. 6 is a flowchart illustrating methods of operating the multi-interface IC card of FIG. 5;

FIG. 7 is a graph illustrating a driving voltage supplied to the multi-interface IC card of FIG. 5;

FIG. 8A illustrates an IC card configured to communicate with a computer system in a USB protocol mode according to some embodiments of the present invention; and

FIG. 8B illustrates an IC card configured to communicate with a mobile phone in a IC_USB protocol mode according to some embodiments of the present invention.

### DETAILED DESCRIPTION

The present invention will now be described more fully hereinafter with reference to the accompanying drawings, in which embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that when an element or layer is referred to as being “on”, “connected to” or “coupled to” another element, it can be directly on, connected or coupled to the other element, or layer or intervening elements may be present. In contrast, when an element is referred to as being “directly on,” “directly connected to” or “directly coupled to” another element, there are no intervening elements or layers present. As used herein, the term “and/or” includes any and all combinations of one or more of the associated listed items.

It will be understood that, although the terms first, second, third etc. may be used herein to describe various elements and/or components, these elements and/or components should not be limited by these terms. These terms are only used to distinguish one element or component from another element or component. Thus, a first element or component discussed below could be termed a second element or component without departing from the teachings of the present invention.

The terminology used herein is for the purpose of describing particular embodiments only, and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. Accordingly, these terms can include equivalent terms that are created after such time. It will be further understood that terms, such as those defined in commonly used dictionaries, should be interpreted as having a meaning that is consistent with their meaning in the present specification and in the context of the relevant art, and will not be interpreted in an idealized or overly formal sense unless expressly so defined herein.

For the ease of explanation, a contact/contactless multi-interface IC card and/or a contact/contactless multi-interface memory card are described herein with reference to supporting a Universal Serial Bus (USB) protocol mode and an InterChip (IC_USB) protocol mode; however, it is to be understood that these particular interfaces/protocol modes are provided by way of example only. Accordingly, embodiments of the present invention are not restricted to these particular interfaces/protocols, and may include other protocols configured to provide communication with one or more host devices.

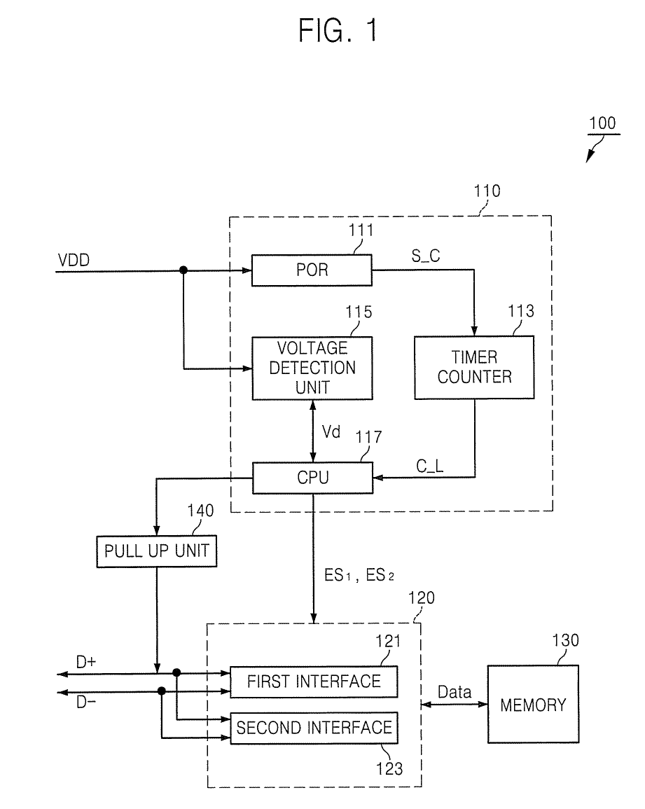

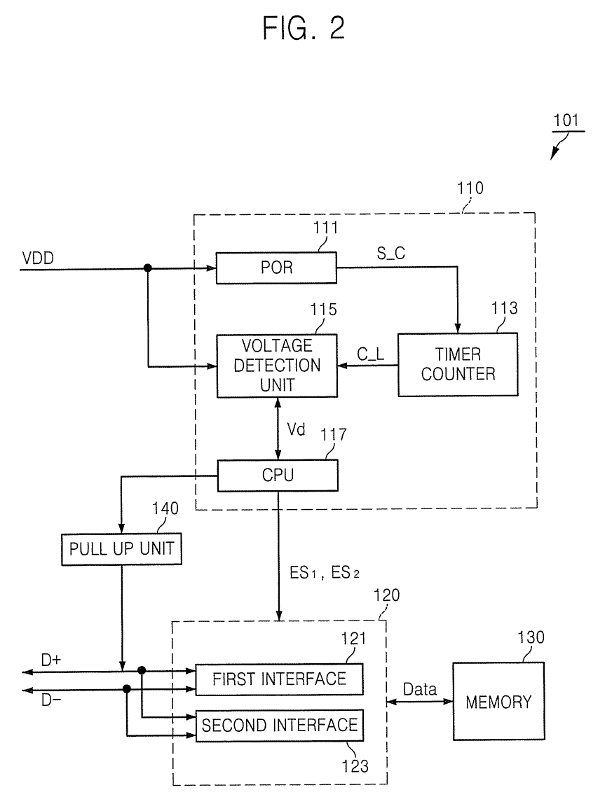

FIG. 1 is a block diagram of a multi-interface IC card according to some embodiments of the present invention, and FIG. 2 is a block diagram of a multi-interface IC card according to other embodiments of the present invention. Referring to FIG. 1, a multi-interface IC card 100 may include a controller 110, a connection unit 120, a memory 130, and a pull-up unit 140.

The controller 110 may include a Power On Reset (POR) 111, a timer counter 113, a voltage detection unit 115, and a central processing unit (CPU) 117. The POR 111 may control an initial operation of each block of the controller 110, e.g., the timer counter 113, the voltage detection unit 115, and/or the CPU 117. Such a POR 111 can be embodied, for example, as a circuit in which MOSFET and a number of inverters are combined; however, embodiments of the present invention are not restricted thereto.

The timer counter 113 performs a counting operation during a predetermined time and/or for a particular duration in response to the POR 111, and outputs a counter value C_L at a predetermined time point. The output counter value C_L may be supplied to the CPU 117. In some embodiments, the timer counter 113 may perform a counting operation in response to the POR 111 during a predetermined time, and may output counter values C_L corresponding to at least two adjacent time points.

The voltage detection unit 115 receives a driving voltage VDD supplied, for example, from an external host device, and senses a level of the driving voltage VDD. The CPU 117, in response to receiving a counter value C_L from the timer counter 113, detects a level Vd of the driving voltage VDD from the voltage detection unit 115 that corresponds to the counter value C_L.

Still referring to FIG. 1, the CPU 117 compares the level Vd of the detected driving voltage with a stored reference voltage Vref, and outputs one of the enable signals ES1 or ES2, e.g., either a first enable signal ES1 or a second enable signal ES2, according to the comparison result. Here, the first enable signal ES1 and the second enable signal ES2 may be substantially the same signal. The reference voltage Vref may be a predetermined voltage level stored in the CPU. For example, in some embodiments, the reference voltage Vref may be approximately 4V to 4.5V.

The connection unit 120 may include a plurality of communication interfaces, such as a first interface 121 and a second interface 123, connected to respective data lines D+ and D−. The connection unit 120 may also enable one of the plurality of interfaces 121 and 123 based on an enable signal ES1 or ES2 supplied from the CPU 117, and may communicate with a host device (not shown) through the enabled interface. For example, the first interface 121 and the second interface 123 may be respectively enabled by the first enable signal ES1 and the second enable signal ES2 supplied from the CPU 117 in response to the detected voltage.

The first interface 121 and the second interface 123 may each communicate with the host device using a different communication protocol. For example, the first interface 121 may be an IC_USB interface configured for communicating with the host device in an IC_USB protocol mode, and the second interface 123 may be a USB interface configured for communicating with the host device in a USB protocol mode.

The memory 130 may be connected to the connection unit 120 and may send and receive data by communicating with the host device through the first interface 121 or the second interface 123 of the connection unit 120. The pull-up unit 140 may be pulled up by one of a number of data lines D+ and D−. In particular, the pull up unit 140 may be pulled-up by the first data line D+, e.g., a positive data line, and may increase an output current of the first data line D+.

Such a pull-up unit 140 may include at least a resistance element (not shown) and a switch (not shown). One terminal of the resistance element may be connected to a predetermined voltage, e.g., the driving voltage VDD, and the other terminal may be connected to one terminal of the switch. The other terminal of the switch may be connected to the first data line D+.

FIG. 2 illustrates a multi-interface IC card 101 according to other embodiments of the present invention. The multi-interface IC card 101 of FIG. 2 is substantially similar to the multi-interface IC card 100 of FIG. 1; that is, the multi-interface IC card 101 of the example embodiment illustrated in FIG. 2 includes a timer counter 113 that outputs a counter value C_L to a voltage detection unit 115, which detects a level of a driving voltage VDD corresponding to the counter value C_L and outputs the detected voltage Vd to the CPU 117.

In particular, as shown in FIG. 2, the timer counter 113 of the IC card 101 performs a counting operation during a predetermined time and/or for a particular duration in response to an output (e.g., S_C) of the POR 111, and outputs a counter value C_L at a predetermined time point to the voltage detection unit 115. The voltage detection unit 115 receives the driving voltage VDD, detects a level of the driving voltage VDD corresponding to the counter value C_L supplied from the timer counter 113, and outputs the detected voltage Vd to the CPU 117.

The CPU 117 compares the detected voltage Vd supplied from the voltage detection unit 115 with a stored reference voltage Vref, and outputs one of the enable signals ES1 or ES2 depending on the comparison result. The first enable signal ES1 and the second enable signal ES2 may be substantially the same signal as described above. Also, the reference voltage Vref may be a predetermined voltage level stored in the CPU 117, and may have a voltage level of, for example, approximately 4.5V.

The output enable signals ES1 and ES2 may respectively enable the first interface 121 and the second interface 123 of the connection unit 120, and the IC card 101 may communicate with a host device using the enabled interface, as discussed above.

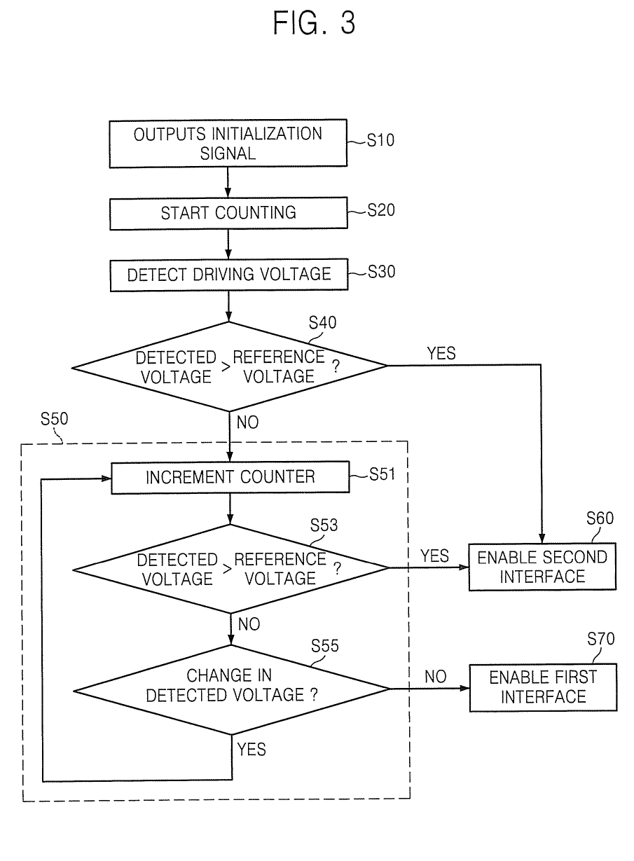

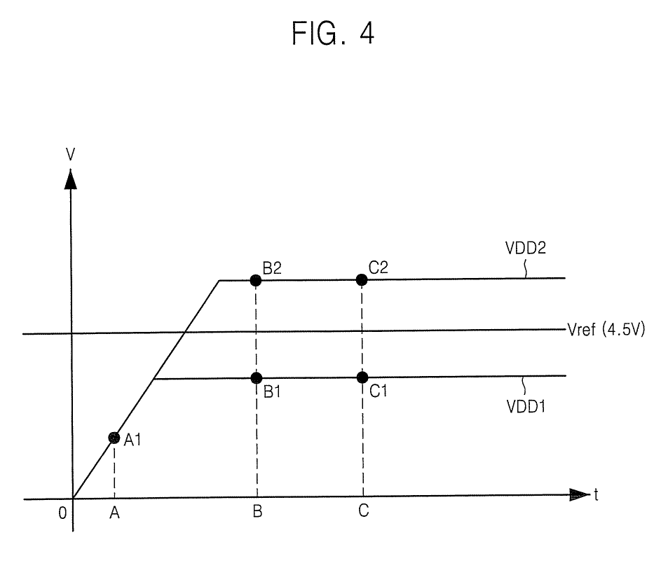

FIGS. 3 and 4 illustrate example operations of the multi-interface IC cards of FIGS. 1 and 2. For the ease of explanation, the embodiments of the present invention will be described below referring to FIGS. 1 and 2 together with FIGS. 3 and 4.

Referring to FIGS. 1 to 4, the IC card 100 (or 101) is connected to a host device (not shown), and the host device supplies the IC card 100 or 101 with a driving voltage VDD. The POR 111 of the IC card 100 or 101 outputs an initialization signal in response to the supplied driving voltage VDD (block S10 of FIG. 3). In particular, the driving voltage VDD supplied from the host is input to the POR 111 of the IC card 100 or 101, and the POR 111 generates the initialization signal S_C when the input driving voltage VDD is more than a certain level, e.g., at a time point A on a time axis t of FIG. 4.

The POR 111 may also generate a reset signal to reset each block in the controller 110, e.g., the above-mentioned timer counter 113, the voltage detection unit 115, and/or the CPU 117, before the driving voltage VDD supplied from the host reaches a certain level, e.g., a voltage level A1 at the time point A on a time axis t. The POR 111 generates the initialization signal S_C when the driving voltage VDD, which is supplied from the host device reaches a certain level or more, e.g., the voltage level A1 at the time point A on the time axis t or more.

The timer counter 113 starts counting in response to the initialization signal S_C output from the POR 111 (block S20). More particularly, the timer counter 113 initiates a counting operation when the initialization signal S_C is provided from the POR 111 at the time point A on a time axis t. The timer counter 113 may output respective counter values at certain time points, e.g., a counter value C_L at the time point B and a counter value C_L at the time point C on the time axis t.

The voltage detection unit 115 detects a level of a driving voltage VDD corresponding to the output counter value C_L (block S30). In particular, referring to FIGS. 1 and 4, the CPU 117 is supplied with a counter value C_L by the timer counter 113 and detects a level of a driving voltage VDD corresponding to the counter value C_L. For example, the CPU 117 may be supplied with the counter value C_L at a time point B on a time axis t by the timer counter 113. In response to the counter value C_L, the CPU 117 may detect a level of a driving voltage VDD at the time point B on a time axis t, e.g., a level B1 of a first driving voltage VDD1 or a level B2 of a second driving voltage VDD2.

The CPU 117 may be supplied with a counter value C_L at the time point B and with a counter value at a neighboring time point C on a time axis t. As such, the counter values at time points B and C may be consecutive values. The CPU 117 may detect a level of a driving voltage VDD at the time point B and at the time point C on a time axis t, e.g., a level B1 and a level C1 of a first driving voltage VDD1 or a level B2 and a level C2 of a second driving voltage VDD2.

Although the CPU 117 is described above as being supplied with a counter value C_L by the timer counter 113 and as detecting a level of a driving voltage corresponding to the counter value, embodiments of the present invention are not limited to such operations. For instance, as illustrated in FIG. 2, the voltage detection unit 115 (rather than the CPU 117) may be supplied with the counter value C_L by the timer counter 113, and may detect a level of the driving voltage VDD corresponding to the counter value in some embodiments. The CPU 117 may thereby be supplied with the level of a detected driving voltage, i.e., a detected voltage Vd, by the voltage detection unit 115.

For example, the voltage detection unit 115 may be supplied with a counter value C_L at the time point B on a time axis t by the timer counter 113. The voltage detection unit 115 may detect a corresponding level of a driving voltage VDD at the time point B on a time axis t, e.g., a level B1 of a first driving voltage VDD1 or a B2 level of a second driving voltage VDD2, in response to the counter value C_L.

The voltage detection unit 115 may also receive a counter value C_L at the time point B and a counter value C_L at the neighboring time point C on a time axis t from the timer counter 113. The voltage detection unit 115 may detect a level of the driving voltage VDD both at the time point B and the time point C on a time axis t, e.g., a level B1 and a level C1 of a first driving voltage VDD1 or a level B2 and a level C2 of a second driving voltage VDD2.

The CPU 117 compares the detected voltage Vd with a reference voltage Vref (block S40). In some embodiments, the CPU 117 may compare a stored reference voltage Vref, e.g., a reference voltage having a voltage level of about 4.5V, with a detected voltage Vd supplied from the external host device corresponding to a counter value C_L generated by the timer counter 113. For instance, the CPU 117 may receive a level of a second driving voltage VDD2 detected at the time point B on a time axis t, e.g., a level B2 of the second driving voltage VDD2, and the CPU 117 may compare the level B2 of the second driving voltage VDD2 with the reference voltage Vref. If the detected level B2 of the second driving voltage VDD2 is greater than the reference voltage Vref (at block S40), the CPU 117 generates a second enable signal ES2 to enable a second interface 123, and may output the enable signal ES2 to the connection unit 120. The connection unit 120 enables the second interface 123 based on the second enable signal ES2 (block S60). Through the enabled second interface 123, the IC card 100 or 101 and the host device may communicate with each other. The first interface 121 of the connection unit 120 may be disabled when the detected voltage is greater than the reference voltage Vref.

However, the CPU 117 may receive a level of a first driving voltage VDD1 detected at a time point B on a time axis t, e.g., a level B1 of the first driving voltage VDD1. The CPU 117 may compare the level B1 of the first driving voltage VDD1 with the reference voltage Vref (block S40). If the level B1 of the first driving voltage VDD1 is less than the reference voltage Vref (at block S40), the CPU 117 activates the timer counter 113 (block S51). In particular, the CPU may increment the timer counter 113. The CPU 117 may receive a next counter value C_L at the next time point, e.g., a time point C on a time axis t, from the timer counter 113, and may detect a level of the driving voltage VDD corresponding to the next counter value. That is, the CPU 117 may receive a level of the driving voltage VDD corresponding to the counter value C_L at the time point C on a time axis t, e.g., a level C1 of the first driving voltage VDD1.

The CPU 117 compares the level C1 of the first driving voltage VDD1 with the reference voltage Vref (block S53). If the level C1 of the first driving voltage VDD1 is greater than the reference voltage Vref, the CPU 117 generates a second enable signal ES2 and outputs the enable signal ES2 to the connection unit 120. The connection unit 120 enables a second interface 123 based on the second enable signal ES2 (block S60), and the IC card 100 or 101 and the host device are able to communicate with each other through the enabled second interface 123.

However, if the level C1 of the first driving voltage VDD1 detected at the time point C on a time axis t is less than the reference voltage Vref, the CPU 117 compares a previously detected voltage Vd, e.g., the level B1 of the first driving voltage VDD1 corresponding to the previous counter value C_L, with the level C1 of the first driving voltage VDD1 corresponding to the next counter value C_L to determine if there has been a change in the detected voltage (block S55).

If the level B1 and the level C1 are substantially the same, the CPU 117 generates a first enable signal ES1 to enable the first interface 121, and outputs the enable signal ES1 to the connection unit 120. The connection unit 120 enables the first interface 121 based on the first enable signal ES1 (block S70), and the IC card 100 or 101 and the host may communicate with each other through the enabled first interface 121. The second interface 123 of the connection unit 120 may be disabled when consecutive values of the detected voltage are both substantially equal and less than the reference voltage Vref.

However, if the compared levels of the first driving voltage VDD1, e.g., the level B1 and the level C1 of the first driving voltage VDD1, are not substantially the same and have changed, the CPU 117 increments the timer counter 113 again (block S51) and repeats the above-mentioned operations S51 to S55. That is, the operations of receiving a counter value at a next time point, i.e., a time point (not shown) on a time axis t, detecting a level of a driving voltage VDD corresponding to the counter value, comparing the level of the detected driving voltage with the reference voltage Vref (block S53), enabling the second interface 123 according to the comparison result (block S60), and comparing the detected detection voltage (Vd), e.g., a level C1 of a first driving voltage VDD1 with a level D1 of a first driving voltage VDD (block S55) are repeated.

The above-described operations may be repeated until the detected voltages corresponding to the counter values supplied from the timer counter 113, are substantially equal value and do not substantially change. In some embodiments, the pull-up unit 140 illustrated in FIGS. 1 and 2 may connect a pulled-up resistance element to a first data line D+ and increase an output current of the first data line D+ when one of the first interface 121 and the second interface 123 is enabled.

In addition, the memory 130 may send and receive data with the host device through the enabled one of the first interface 121 and the second interface 123. That is, in a multi-interface IC card according to embodiments of the present invention as described above with reference to FIGS. 1 through 4, may support at least two different protocol modes, and may communicate with host devices using various protocol modes by detecting the driving voltage VDD supplied from the host device at one or more certain time points, comparing the detected driving voltage with a reference voltage Vref, and controlling the operation of the first interface 121 and the second interface 123 of the connection unit 120 according to the comparison result.

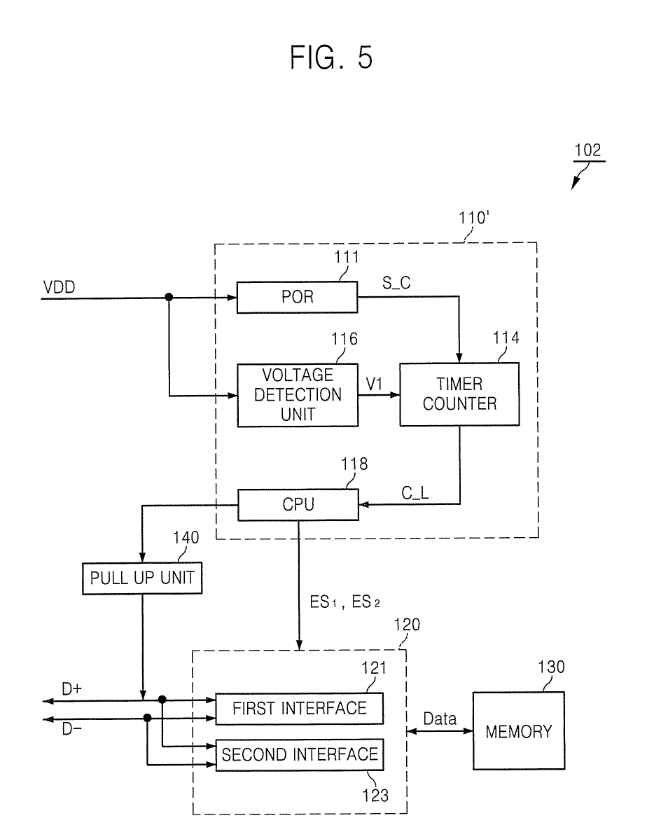

The following is a description of operations performed by a multi interface IC card according to further embodiments of the present invention with reference to FIGS. 5 to 7. Components or elements having similar functionality as components/elements illustrated in FIGS. 1 and 2 are referred to by the same reference designators, and further description of these components/elements may be omitted for the sake of brevity.

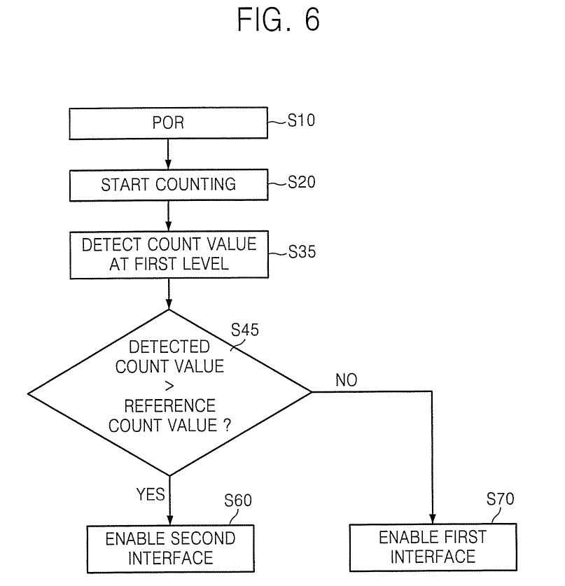

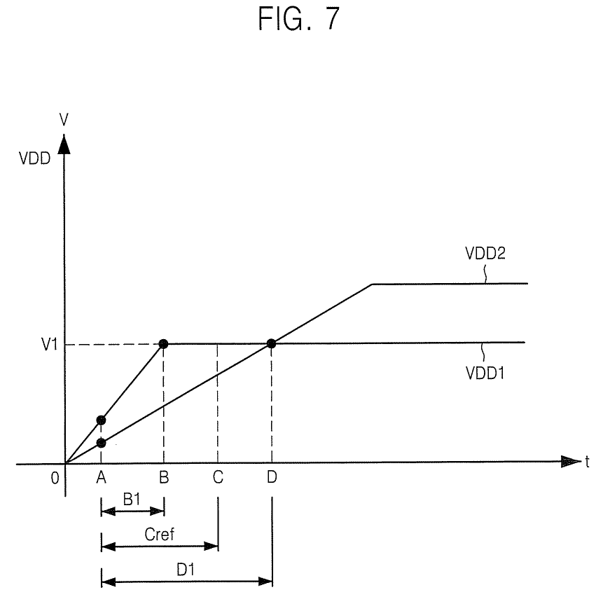

FIG. 5 is a block diagram of a multi-interface IC card according to further embodiments of the present invention, FIG. 6 is a flowchart illustrating operations of the multi interface IC card of FIG. 5, and FIG. 7 illustrates a driving voltage at particular time points provided to the multi-interface IC card of FIG. 5.

Referring now to FIG. 5, the multi-interface IC card 102 includes a controller 110′, a connection unit 120, a memory 130, and a pull-up unit 140. The controller 110′ may include a POR 111, a timer counter 114, a voltage detection unit 116, and a CPU 118.

The POR 111, the connection unit 120, the memory 130, and the pull-up unit 140 of FIG. 5 may be substantially similar to the corresponding components described above with reference to FIGS. 1 and 2. The voltage detection unit 116 of the controller 110′ receives and senses a driving voltage VDD from a host device (not shown) and detects when the driving voltage reaches a certain level, e.g., a first voltage level V1.

The timer counter 114 performs a counting operation in response to the POR 111 and outputs a counter value C_L when a level of a driving voltage detected by the voltage detection unit 116, i.e., a first voltage level V1, is detected. More particularly, the voltage detection unit 116 senses a driving voltage VDD and detects and outputs the sensed driving voltage VDD to the timer counter 114 once it reaches the first voltage level V1. The timer counter 114 initiates a counting operation in response to an initialization signal S_C from the POR 111 and outputs a counter value C_L when a level of a driving voltage detected by the voltage detection unit 116, reaches the first voltage level V1. In particular, the timer counter 114 starts a counting operation whereby an initial counter value is repeatedly incremented in response to the initialization signal S_C output from the POR 111. The timer counter 114 also terminates or stops the counting operation when the first voltage level V1 is output from the voltage detection unit 116, and outputs a counter value C_L corresponding to the time when the driving voltage VDD reached the first voltage level V1.

The CPU 118 compares the counter value C_L output from the timer counter 114 with a predetermined reference counter value Cref. The predetermined reference counter value Cref may be previously stored in the CPU 118. The CPU 118 outputs one of two enable signals, e.g., a first enable signal ES1 and a second enable signal ES2, to control operation of the connection unit 120 according to the comparison result. The enable signals ES1 and ES2 may be substantially the same as described above with reference to FIGS. 1 through 4. The enable signals ES1 and ES2 output from the CPU 118 respectively enable a first interface 121 and a second interface 123 of the connection unit 120, and the connection unit 120 may communicate with a host via the enabled interface 121 or 123.

The following is detailed explanation for the operation of the multi interface IC card of FIG. 5 with reference to FIGS. 6 and 7. When the IC card 102 is connected to a host device (not shown), the host device supplies a driving voltage VDD to the IC card 102. The IC card 102 activates a POR in response to the supplied driving voltage VDD (block S10). In particular, the driving voltage VDD supplied from the host is input to the POR 111 of the IC card 103, and the POR 111 generates an initialization signal S_C, to ready each block of the controller 110 for driving, when the input driving voltage VDD is greater than a certain level, e.g., at the time point A on a time axis t.

The timer counter 114 initiates a counting operation in response to the initialization signal S_C output from the POR 111 (block S20). More particularly, the timer counter 114 begins the counting operation when the initialization signal S_C is received from the POR 111 at the time point A on a time axis t.

The voltage detection unit 116 senses each amplitude (or level) of the driving voltages supplied from the host device, e.g., a first driving voltage VDD1 or a second driving voltage VDD2, which have different rising slope each other, in response to the initialization signal S_C output from the POR 111. The timer counter 114 terminates or stops the counting operation at the time point when the first driving voltage VDD1 sensed by the voltage detection unit 116 reaches the first voltage level V1. The timer counter 114 detects and outputs a counter value C_L (which may have a value of B1) at the corresponding time point, e.g., the time point B on a time axis t (block S35).

The timer counter 114 may also stop the counting operation at the time point when a second driving voltage VDD2 sensed by the voltage detection unit 116 reaches the first voltage level V1. The timer counter 114 may thereby detect and output a counter value D1 at the time point, e.g., the time point D on a time axis t.

The CPU 118 compares the detected counter value C_L with a stored reference counter value Cref (block S45). In particular, the CPU 118 compares the counter value C_L output from the timer counter 114 with a reference counter value Cref and generates an enable signal ES1 or ES2 according to the comparison result. For example, the CPU 118 may be supplied a counter value B1 of a first driving voltage VDD1, which is detected at a time point B on a time axis t, from the timer counter 114. The CPU 118 compares the counter value B1 of the first driving voltage VDD1 with the reference counter value Cref. When the counter value B1 of the first driving voltage VDD1 is less than the reference counter value Cref, the CPU 118 generates the first enable signal ES1 to enable the first interface 121 and outputs the enable signal ES1 to a connection unit 120.

The CPU 118 may be also supplied a counter value D1 of a second driving voltage VDD2, which is detected at a time point D on a time axis t, from the timer counter 114. The CPU 118 compares the counter value D1 of the second driving voltage VDD2 with the reference counter value Cref. When the counter value D1 of the second driving voltage VDD2 is greater than the reference counter value Cref, the CPU 118 generates the second enable signal ES2 to enable a second interface 123 and outputs the enable signal ES2 to the connection unit 120. Accordingly, one of the output enable signals ES1 or ES2 is supplied to the connection unit 120 to enable either the first interface 121 (block S70) or the second interface 123 (S60) based on the enable signal ES1 or ES2.

For example, the connection unit 120 may enables the first interface 121 based on the first enable signal ES1 (S70) and the IC card 102 may communicate with the host device using the enabled first interface 121. The second interface 123 of the connection unit 120 may thereby be disabled in response to the enable signal ES1. Alternatively, the connection unit 120 may enable the second interface 123 based on the second enable signal ES2 (block S60). The IC card 102 and the host device may communicate with each other through the enabled second interface 123. The first interface 121 of the connection unit 120 may thereby be disabled in response to the enable signal ES2.

The first interface 121 and the second interface 123 of the connection unit 120 of the IC card 102 described above, may each communicate with the host device according to different communication protocols. For instance, the first interface 121 may be configured to communicate with the host device in an IC_USB protocol mode, while the second interface 123 may be configured to communicate with the host in an USB protocol mode. In addition, the first driving voltage VDD1 supplied from a host may be an IC_USB driving voltage having a relatively steep rising slope, while the second driving voltage VDD2 may be a USB driving voltage having a relatively gentle rising slope compared to the first driving voltage VDD1.

The following examples describe communication between IC cards according to some embodiments of the present invention and a plurality of host devices, each of which support a different protocol method. For ease of explanation, the following examples refer to the multi-interface IC card as illustrated in FIG. 1; however the present invention is not restricted to such examples, and the multi-interface IC cards 101 or 102 of FIGS. 2 and 5 may also be used.

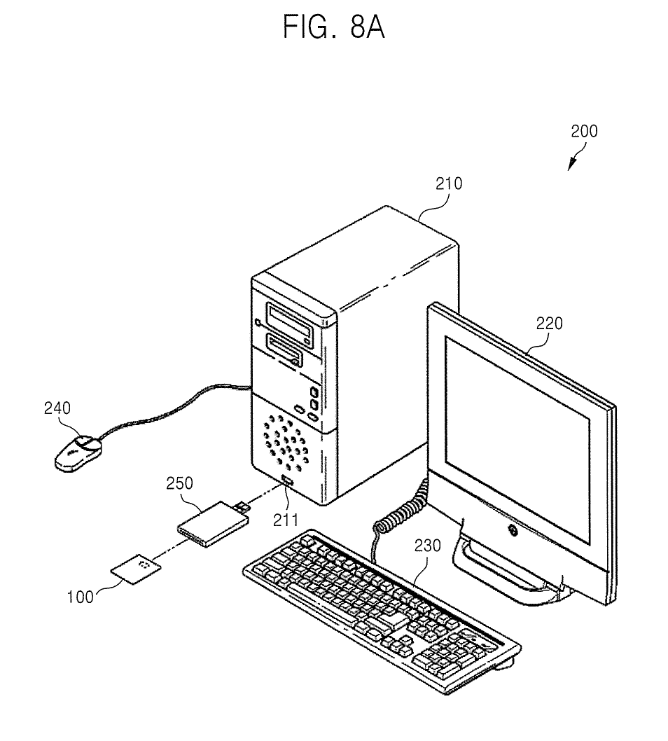

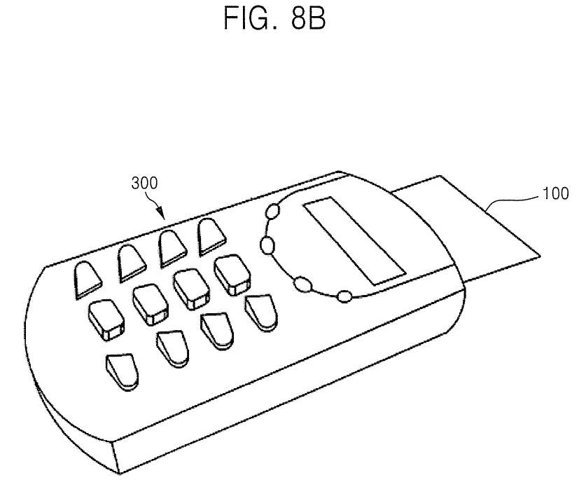

FIG. 8A illustrates communication between an IC card and a computer system using a USB protocol mode, while FIG. 8B illustrates communication between an IC card and a mobile phone using an IC_USB protocol mode. The IC card 100 may support multiple interfaces, e.g., a USB interface and an IC_USB interface, as explained above.

As shown in FIG. 8A, a computer system 200 includes a reader 250 which is inserted in a computer 210, a monitor (or display) 220, a keyboard 230, a mouse 240, and an IC card 100 capable of communicating with the computer system 200. The reader 250 may be connected to a USB port 211 installed in the computer 210. When the IC card 100 is connected to the computer system 200 through the reader 250, the IC card 100 may receive a driving voltage VDD, e.g., a driving voltage of approx. 4.7V to 5.0V, from the computer system (host device) 200. Accordingly, the IC card 100 may communicate with the computer system 200 by enabling a USB interface according to the supplied driving voltage VDD as explained above with reference to FIGS. 1 to 4.

As shown in FIG. 8B, the IC card 100 may be also inserted and connected in a mobile device, e.g., a mobile phone 300. The IC card 100 may receive a driving voltage VDD, e.g., a driving voltage VDD of approx. 1.8V to 3.3V, from the mobile phone 300. Accordingly, as explained above with reference to FIGS. 1 through 4, the IC card 100 may communicate with the mobile phone 300 by enabling an IC_USB interface according to the supplied driving voltage VDD.

Thus, multi-interface IC cards according to embodiments of the present invention include interfaces capable of communicating with a host device using different communication protocol modes, and may thereby communicate with a plurality of different host devices having various protocol modes by selecting one of the interfaces in response to a driving voltage supplied from the host device.

Although example embodiments of the present general inventive concept have been shown and described herein, it will be appreciated by those skilled in the art that many changes may be made in these embodiments without departing from the principles and spirit of the general inventive concept, the scope of which is defined by the appended claims and their equivalents.

That which is claimed:

1. A multi-interface integrated circuit (IC) card, comprising:
a first communication interface configured to communicate with a host device in a first protocol mode;
a second communication interface configured to communicate with the host device in a second protocol mode different than the first protocol mode; and
a controller configured to detect a voltage supplied by the host device and a counter value associated therewith, and configured to enable either the first interface or the second interface according to the detected voltage and the counter value.

2. The multi-interface IC card of claim 1, wherein the controller is configured to detect the voltage in response to the counter value, compare the detected voltage with a reference voltage, and enable either the first interface or the second interface in response to the comparison.

3. The multi-interface IC card of claim 2, wherein the controller comprises:
a counter configured to output the counter value therefrom at a predetermined time;
a voltage detection unit coupled to the host device and configured to receive the voltage supplied thereby; and
a processing unit coupled to the counter and the voltage detection unit, wherein the processing unit is configured to detect the voltage in response to the counter value from the counter, compare the detected voltage with the reference voltage, and output an enable signal to enable either the first interface or the second interface in response to the comparison.

4. The multi-interface IC card of claim 3, wherein the processing unit is configured to enable the first interface in response to the comparison indicating that the detected voltage is less than the reference voltage, and is configured to enable the second interface in response to the comparison indicating that the detected voltage is greater than the reference voltage.

5. The multi-interface IC card of claim 3, wherein the voltage comprises a first voltage, wherein the counter is configured to output a second counter value after the predetermined time, and wherein the processing unit is configured to detect a second voltage from the host device in response to the second counter value from the counter, compare the detected second voltage with the reference voltage, and output the enable signal in response to the second comparison.

6. The multi-interface IC card of claim 5, wherein the first and second counter values comprise consecutive counter values, and wherein the counter is configured to output the second counter value by incrementing the first counter value in response the first comparison indicating that the first voltage is less than the reference voltage.

7. The multi-interface IC card of claim 6, wherein the processing unit is configured to enable the second interface in response to the second comparison indicating that the second voltage is greater than the reference voltage, and wherein the processing unit is configured to enable the first interface in response to the first and second comparisons indicating that the respective first and second voltages are substantially equal and less than the reference voltage.

8. The multi-interface IC card of claim 3, wherein the controller further comprises:
a Power-On Reset (POR) coupled to the counter and configured to generate an initialization signal in response to the voltage from the host device,
wherein the counter is configured to initiate a counting operation whereby an initial value is repeatedly incremented to provide the counter value at the predetermined time in response to the initialization signal.

9. The multi-interface IC card of claim 1, wherein the controller further comprises:
a counter configured to receive a signal from a Power-On Reset (POR) and output the counter value therefrom at a predetermined time in response to the signal;
a voltage detection unit coupled to the host device and the counter and configured to detect the voltage supplied thereby in response to the counter value from the counter; and
a processing unit coupled to the voltage detection device and configured to compare the detected voltage with the reference voltage and output an enable signal to enable either the first interface or the second interface in response to the comparison.

10. The multi-interface IC card of claim 1, wherein the controller is configured to detect the counter value in response to a voltage comparison of the detected voltage from the host device and a reference voltage, compare the detected counter value with a reference counter value, and enable the one of the first interface and the second interface in response to the counter value comparison.

11. The multi-interface IC card of claim 10, wherein the controller comprises:
a voltage detection unit configured to detect the voltage from the host device and compare the detected voltage with the reference voltage;
a counter coupled to the voltage detection unit and configured to output the counter value therefrom in response to a voltage comparison result indicating that the detected voltage is greater than the reference voltage; and
a processing unit coupled to the counter and configured to compare the detected counter value with the reference counter value and output an enable signal to enable either the first interface or the second interface in response to a counter value comparison result.

12. The multi-interface IC card of claim 11, wherein the processing unit is configured to enable the first interface in response to the counter value comparison result indicating that the detected counter value is less than the reference counter value, and enable the second interface in response to the counter value comparison result indicating that the detected counter value is greater than the reference counter value.

13. The multi-interface IC card of claim 11, wherein the controller further comprises:
a Power-On Reset (POR) coupled to the counter and configured to generate an initialization signal in response to the voltage supplied by the host device,
wherein the counter is configured to initiate a counting operation whereby an initial value is repeatedly incremented in response to the initialization signal from the POR, and terminate the counting operation to provide the counter value in response to the voltage comparison result indicating that the voltage is greater than or equal to the reference voltage.

14. The multi-interface IC card of claim 11, wherein the first interface comprises an InterChip (IC_USB) interface, and wherein the second interface comprises a Universal Serial Bus (USB) interface.

15. A method for controlling access to data stored on multi-interface integrated circuit (IC) card including first and second communication interfaces configured to communicate with a host device using different protocols, the method comprising:
detecting, by a controller, a voltage supplied by the host device and a counter value associated therewith; and
enabling, by the controller, either the first interface or the second interface according to the detected voltage and the counter value.

16. The method of claim 15, wherein detecting comprises providing the counter value from a counter included in the IC card and detecting the voltage in response to the counter value from the counter, and wherein enabling comprises comparing the detected voltage with a reference voltage and outputting an enable signal to enable either the first interface or the second interface in response to the comparison.

17. The method of claim 16, further comprising:
providing a second counter value from the counter after the predetermined time;
detecting a second voltage from the host device in response to the second counter value from the counter;
comparing the detected second voltage with the reference voltage; and
outputting the enable signal in response to the comparison of the second voltage.

18. The method of claim 17, wherein outputting the enable signal comprises:
outputting the enable signal to enable the second interface in response to the comparison of the second voltage indicating that the second voltage is greater than the reference voltage; and
outputting the enable signal to enable the first interface in response to the comparisons of the first and second voltages indicating that the respective first and second voltages are substantially equal and less than the reference voltage.

19. The method of claim 15, wherein detecting comprises detecting the voltage supplied by the host device, comparing the detected voltage with a reference voltage, and providing the counter value from a counter in response to a voltage comparison result indicating that the detected voltage is greater than the reference voltage, and wherein enabling comprises comparing the detected counter value with the reference counter value, and outputting an enable signal to enable either the first interface or the second interface in response to a counter value comparison result.

20. The method of claim 19, wherein providing the counter value comprises:
initiating a counting operation whereby an initial value is repeatedly incremented in response to an initialization signal from a Power-On Reset (POR); and
terminating the counting operation to provide the counter value in response to the voltage comparison result indicating that the voltage is greater than or equal to the reference voltage.
